(19) United States
(12) Patent Application Publication
(10) Pub. No.: US 2009/0327939 A1
(43) Pub. Date: Dec. 31, 2009

(54) SYSTEMS AND METHODS FOR FACILITATING ACCESS TO CONTENT INSTANCES USING GRAPHICAL OBJECT REPRESENTATION

(75) Inventors: Greg Johns, Irving, TX (US); Brent Ziemann, Euless, TX (US)

Correspondence Address: VERIZON;PATENT MANAGEMENT GROUP, 1320 North Court House Road, 9th Floor, ARLINGTON, VA, 22201-2909, US

(73) Assignee: VERIZON DATA SERVICES LLC, Temple Terrace, FL (US)

(21) Appl. No.: 12/115,173

(22) Filed: May 5, 2008

(51) Int. Cl. G06F 3/048

(52) U.S. Cl. 715/765; 715/784

(57) ABSTRACT

An exemplary system includes a content access subsystem configured to maintain a plurality of content instances, provide a first set of one or more graphical objects to a display for presentation to a user, select one of the graphical objects in response to an input command, and provide a second set of one or more graphical objects to a display for presentation to the user, the second set of one or more graphical objects being filtered in accordance with the selection of the graphical object in the first content level. Each of the graphical objects within the first set of graphical objects is configured to represent an entry within a first content level corresponding to a first metadata value associated with the content instances. Each of the graphical objects within the second set of graphical objects is configured to represent an entry within a second content level corresponding to a second metadata value associated with the content instances.

### BACKGROUND INFORMATION

Advances in electronic communications technologies have interconnected people and allowed for distribution of information perhaps better than ever before. To illustrate, personal computers, handheld devices, cellular telephones, and other electronic devices are increasingly being used to access, store, download, share, and/or otherwise process various types of content (e.g., video, audio, photographs, and/or multimedia).

Increased electronic storage capacities have allowed many users to amass large electronic libraries of content. For example, many electronic devices are capable of storing thousands of audio, video, image, and other multimedia content files.

A common problem associated with such large electronic libraries of content is searching for and retrieving desired content within the library. Text searching techniques (e.g., title searches) are often used. In certain cases, however, textual searches and other conventional techniques for searching for content are cumbersome, difficult to use, impractical, and time consuming.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary system configured to facilitate access to content according to principles described herein.

FIG. 2 illustrates an exemplary content access subsystem according to principles described herein.

FIG. 3 illustrates an exemplary implementation of the content access subsystem of FIG. 2 according to principles described herein.

FIG. 4 is a graphical representation of a number of content levels according to principles described herein.

FIG. 5 illustrates an exemplary graphical user interface (“GUI”) configured to facilitate content level navigation according to principles described herein.

FIG. 6 shows the GUI of FIG. 5 after an up directional key has been pressed according to principles described herein.

FIG. 7 shows the GUI of FIG. 5 with contextual information corresponding to a graphical object displayed therein according to principles described herein.

FIG. 8 shows the GUI of FIG. 5 after a particular graphical object has been selected according to principles described herein.

FIG. 9 shows the GUI of FIG. 8 after a particular graphical object has been selected according to principles described herein.

FIGS. 10A-10B illustrate an exemplary GUI configured to present one or more graphical objects in a stacked S-curve arrangement according to principles described herein.

FIGS. 11A-11D illustrate various screen shots of the GUI of FIGS. 10A-10B as the scrolling speed increases according to principles described herein.

FIG. 12 illustrates a graphical overlay configured to provide contextual information corresponding to one or more entries within a content level according to principles described herein.

FIG. 13 illustrates an exemplary content instance locating method according to principles described herein.

### DETAILED DESCRIPTION OF PREFERRED EMBODIMENTS

Exemplary systems and methods for facilitating access to one or more content instances using graphical object representations (or simply “graphical objects”) are described herein. The exemplary systems and methods may provide an intuitive and efficient experience for users desiring to locate and/or access one or more content instances within a content library.

As will be described below, one or more graphical objects may be configured to represent one or more corresponding entries within one or more content levels. Each content level corresponds to a metadata attribute associated with the content instances included within a content library. In order to locate and/or access a desired content instance within the content library, a user may navigate through a hierarchy of content levels by selecting one or more of the graphical objects associated with the entries in the content levels.

In some examples, such content level navigation may be performed by using only directional keys that are a part of a content access subsystem or device (e.g., a cellular phone, handheld media player, computer, etc.). In this manner, a user may quickly and efficiently access a desired content instance without having to enter text queries, for example.

As used herein, the term “content instance” refers generally to any data record or object (e.g., an electronic file) storing, including, or otherwise associated with content, which may include data representative of a song, audio clip, movie, video, image, photograph, text, document, application file, alias, or any segment, component, or combination of these or other forms of content that may be experienced or accessed by a user. A content instance may have any data format as may serve a particular application. For example, a content instance may include an audio file having an MP3, WAV, AIFF, AU, or other suitable format, a video file having an MPEG, MPEG-2, MPEG-4, MOV, DMF, or other suitable format, an image file having a JPEG, BMP, TIFF, RAW, PNG, GIF or other suitable format, and/or a data file having any other suitable format.

The term “metadata” as used herein refers generally to any electronic data descriptive of content and/or content instances. Hence, metadata may include, but is not limited to, time data, physical location data, user data, source data, destination data, size data, creation data, modification data, access data (e.g., play counts), and/or any other data descriptive of content and/or one or more content instances. For example, metadata corresponding to a song may include a title of the song, a name of the song's artist or composer, a name of the song's album, a genre of the song, a length of the song, one or more graphics corresponding to the song (e.g., album art), and/or any other information corresponding to the song as may serve a particular application. Metadata corresponding to a video may include a title of the video, a name of one or more people associated with the video (e.g., actors, producers, creators, etc.), a rating of the video, a synopsis of the video, and/or any other information corresponding to the video as may serve a particular application. Metadata corresponding to other types of content instances may include additional or alternative information.

The term “metadata attribute” will be used herein to refer to a particular category or type of metadata. For example, an exemplary metadata attribute may include, but is not limited to, a content instance title category, an artist name category, an album name category, a genre category, a size category, an access data category, etc. Metadata associated with a content instance may have at least one metadata value corresponding to each metadata attribute. A metadata value for a category of artists metadata attribute may include “The Beatles,” for example.

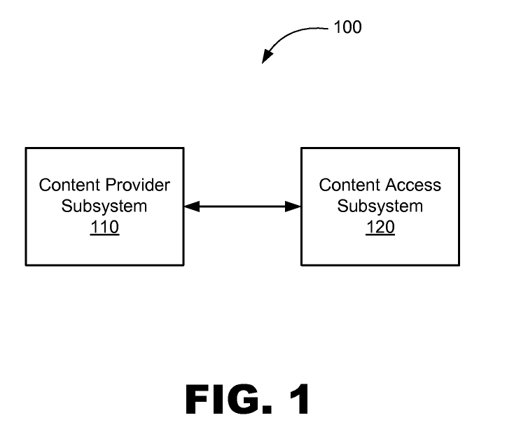

FIG. 1 illustrates an exemplary system 100 configured to facilitate access to content. As shown in FIG. 1, system 100 may include a content provider subsystem 110 selectively and communicatively coupled to a content access subsystem 120.

Content provider subsystem 110 and content access subsystem 120 may communicate using any communication platforms and technologies suitable for transporting data, including known communication technologies, devices, media, and protocols supportive of data communications, examples of which include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Short Message Service (“SMS”), Multimedia Message Service (“MMS”), socket connections, signaling system seven (“SS7”), Ethernet, in-band and out-of-band signaling technologies, and other suitable communications networks and technologies.

In some examples, content provider subsystem 110 and content access subsystem 120 may communicate via one or more networks, including, but not limited to, wireless networks, mobile telephone networks, broadband networks, narrowband networks, closed media networks, cable networks, satellite networks, subscriber television networks, the Internet, intranets, local area networks, public networks, private networks, optical fiber networks, and/or any other networks capable of carrying data and communications signals between content provider subsystem 110 and content access subsystem 120.

In some examples, one or more components of system 100 may include any computer hardware, software, instructions, and/or any combination thereof configured to perform the processes described herein. In particular, it should be understood that one or more components of system 100 may be implemented on one physical computing device or may be implemented on more than one physical computing device. For example, content provider subsystem 110 and content access subsystem 120 may be implemented on one physical computing device or on more than one physical computing device. Accordingly, system 100 may include any one of a number of computing devices, and may employ any of a number of computer operating systems.

Accordingly, one or more processes described herein may be implemented at least in part as computer-executable instructions, i.e., instructions executable by one or more computing devices, tangibly embodied in a computer-readable medium. In general, a processor (e.g., a microprocessor) receives instructions, e.g., from a memory, a computer-readable medium, etc., and executes those instructions, thereby performing one or more processes, including one or more of the processes described herein. Such instructions may be stored and transmitted using a variety of known computer-readable media.

A computer-readable medium (also referred to as a processor-readable medium) includes any medium that participates in providing data (e.g., instructions) that may be read by a computer (e.g., by a processor of a computer). Such a medium may take many forms, including, but not limited to, non-volatile media, volatile media, and transmission media. Non-volatile media may include, for example, optical or magnetic disks and other persistent memory. Volatile media may include, for example, dynamic random access memory (“DRAM”), which typically constitutes a main memory. Transmission media may include, for example, coaxial cables, copper wire and fiber optics, including the wires that comprise a system bus coupled to a processor of a computer. Transmission media may include or convey acoustic waves, light waves, and electromagnetic emissions, such as those generated during radio frequency (“RF”) and infrared (“IR”) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Content provider subsystem 110 may be configured to provide various types of content and/or data associated with content to content access subsystem 120 using any suitable communication technologies, including any of those disclosed herein. The content may include one or more content instances, or one or more segments of the content instance(s).

An exemplary content provider subsystem 110 may include a content provider server configured to communicate with content access subsystem 120 via a suitable network. In some alternative examples, content provider subsystem 110 may be configured to communicate directly with content access subsystem 120. For example, content provider subsystem 110 may include a storage medium (e.g., a compact disk or a flash drive) configured to be read by content access subsystem 120.

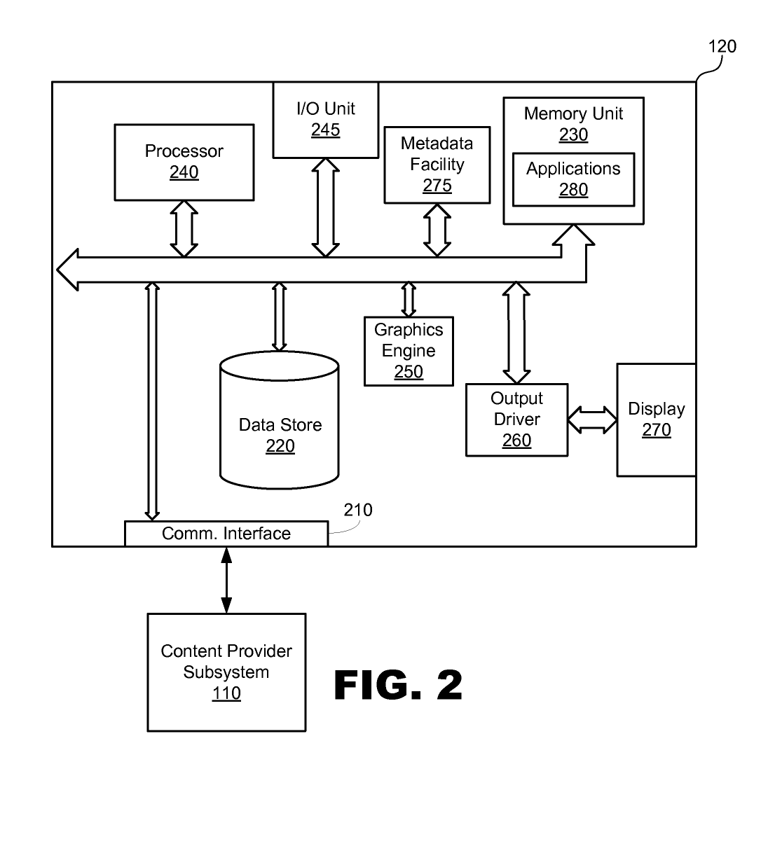

FIG. 2 illustrates an exemplary access subsystem 120 (or simply “access subsystem 120”). Access subsystem 120 may include any hardware, software, firmware, or combination or sub-combination thereof, configured to facilitate access to one or more content instances. In some examples, access subsystem 120 may additionally or alternatively process one or more content instances for presentation to a user.

To this end, access subsystem 120 may include, but is not limited to, one or more wireless communication devices (e.g., cellular telephones and satellite pagers), handheld media players (e.g., audio and/or video players), wireless network devices, VoIP phones, video phones, broadband phones (e.g., Verizon® One phones and Verizon® Hub phones), video-enabled wireless phones, desktop computers, laptop computers, tablet computers, personal computers, personal data assistants, mainframe computers, mini-computers, vehicular computers, entertainment devices, gaming devices, music devices, video devices, closed media network access devices, set-top boxes, digital imaging devices, digital video recorders, personal video recorders, and/or content recording devices (e.g., video cameras such as camcorders and still-shot digital cameras). Access subsystem 120 may also be configured to interact with various peripherals such as a terminal, keyboard, mouse, display screen, printer, stylus, input device, output device, or any other apparatus.

As shown in FIG. 2, the access subsystem 120 may include a communication interface 210, data store 220, memory unit 230, processor 240, input/output unit 245 (“I/O unit 245”), graphics engine 250, output driver 260, display 270, and metadata facility 275 communicatively connected to one another. While an exemplary access subsystem 120 is shown in FIG. 2, the exemplary components illustrated in FIG. 2 are not intended to be limiting. Indeed, additional or alternative components and/or implementations may be included within the access subsystem 120.

Communication interface 210 may be configured to send and receive communications, including sending and receiving data representative of content to/from content provider subsystem 110. Communication interface 210 may include any device, logic, and/or other technologies suitable for transmitting and receiving data representative of content. The communication interface 210 may be configured to interface with any suitable communication media, protocols, formats, platforms, and networks, including any of those mentioned herein.

Data store 220 may include one or more data storage media, devices, or configurations and may employ any type, form, and combination of storage media. For example, the data store 220 may include, but is not limited to, a hard drive, network drive, flash drive, magnetic disc, optical disc, or other non-volatile storage unit. Data, including data representative of one or more content instances and metadata associated with the content instances, may be temporarily and/or permanently stored in the data store 220.

Memory unit 230 may include, but is not limited to, FLASH memory, random access memory (“RAM”), dynamic RAM (“DRAM”), or a combination thereof. In some examples, as will be described in more detail below, applications executed by the access subsystem 120 may reside in memory unit 230.

Processor 240 may be configured to control operations of components of access subsystem 120. Processor 240 may direct execution of operations in accordance with computer-executable instructions such as may be stored in memory unit 230. As an example, processor 240 may be configured to process content, including decoding and parsing received content and encoding content for transmission to another access subsystem 120.

I/O unit 245 may be configured to receive user input and provide user output and may include any hardware, firmware, software, or combination thereof supportive of input and output capabilities. For example, I/O unit 245 may include one or more devices for acquiring content, including, but not limited to, a still-shot and/or video camera, scanner, microphone, keyboard or keypad, touch screen component, and receiver (e.g., an infrared receiver). Accordingly, a user of access subsystem 120 can create a content instance (e.g., by taking a picture) and store and/or transmit the content instance to content provider subsystem 110 for storage.

As instructed by processor 240, graphics engine 250 may generate graphics, which may include one or more graphical user interfaces (“GUIs”). The output driver 260 may provide output signals representative of the graphics generated by graphics engine 250 to display 270. The display 270 may then present the graphics for experiencing by the user.

Metadata facility 275 may be configured to perform operations associated with content metadata, including generating, updating, and providing content metadata. Metadata facility 275 may include hardware, computer-readable instructions embodied on a computer-readable medium such as data store 220 and/or memory unit 230, or a combination of hardware and computer-readable instructions. In certain embodiments, metadata facility 275 may be implemented as a software application embodied on a computer-readable medium such as memory unit 230 and configured to direct the processor 240 of the access subsystem 120 to execute one or more of metadata operations described herein.

Metadata facility 275 may be configured to detect content management operations and to generate, update, and provide metadata associated with the operations. For example, when a content instance is created, metadata facility 275 may detect the creation of the content instance and identify and provide one or more metadata attributes and values associated with the content instance. The metadata may be stored within a content instance and/or within a separate data structure as may serve a particular application.

One or more applications 280 may be executed by the access subsystem 120. The applications, or application clients, may reside in memory unit 230 or in any other area of the access subsystem 120 and may be executed by the processor 240. Each application 280 may correspond to a particular feature, feature set, or capability of the access subsystem 120. For example, illustrative applications 280 may include a search application, an audio application, a video application, a multimedia application, a photograph application, a codec application, a particular communication application (e.g., a Bluetooth or Wi-Fi application), a communication signaling application, and/or any other application representing any other feature, feature set, or capability of access subsystem 120. In some examples, one or more of the applications 280 may be configured to direct the processor 240 to search for one or more desired content instances stored within access subsystem 120 and/or available via content provider subsystem 110.

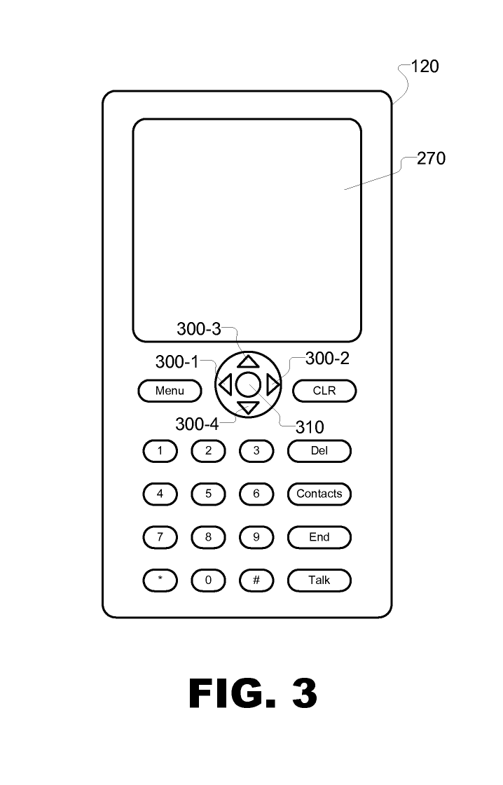

FIG. 3 illustrates an exemplary implementation of the content access subsystem 120 of FIG. 2. Access subsystem 120 is in the form of a mobile phone (e.g., a cellular phone) in FIG. 3 for illustrative purposes only. As shown in FIG. 3, access subsystem 120 may include at least the display 270, one or more directional keys (e.g., left directional key 300-1, right directional key 300-2, up directional key 300-3, and down directional key 300-4, collectively referred to herein as “directional keys 300”), and a select key 310. The directional keys 300 and select key 310 may be configured to facilitate transmission by a user of one or more input commands to access subsystem 120. In this manner, the user may navigate through one or more graphical user interfaces (“GUIs”) that may be displayed by access subsystem 120 on display 270. Similar keys or buttons may be included within other implementations of access subsystem 120 as may serve a particular application. As will be described in more detail below, the directional keys 300 may be used to search for and access a desired content instance.

Access subsystem 120 may be configured to store and search through large electronic libraries of content. For example, a user may download or otherwise obtain and store tens of thousands of content instances within access subsystem 120. Network-enabled access subsystems 120 may additionally or alternatively access millions of content instances stored within content provider subsystem 110 and/or any other connected device or subsystem storing content.

It is often difficult and cumbersome to search through a large content library and locate a content instance of interest that is stored within the content library. The exemplary systems and methods described herein allow a user to locate and/or access a particular media content instance stored within a content library by navigating, filtering, or “drilling down” through a hierarchy of content levels. As the user navigates through a series of content levels, a “navigation thread” is created. To this end, access subsystem 120 may be configured to provide various GUIs configured to facilitate content level navigation and filtering, as will be described in more detail below.

As used herein, a “content level” (or simply “level”) corresponds to a particular metadata attribute. To illustrate, a content level may be associated with any metadata attribute of a song (e.g., the name of the song's artist, the name of the song's album, the genre of the song, the length of the song, the title of the song, and/or any other attribute of the song.) Additional or alternative content levels may be associated with other metadata attributes of content as may serve a particular application.

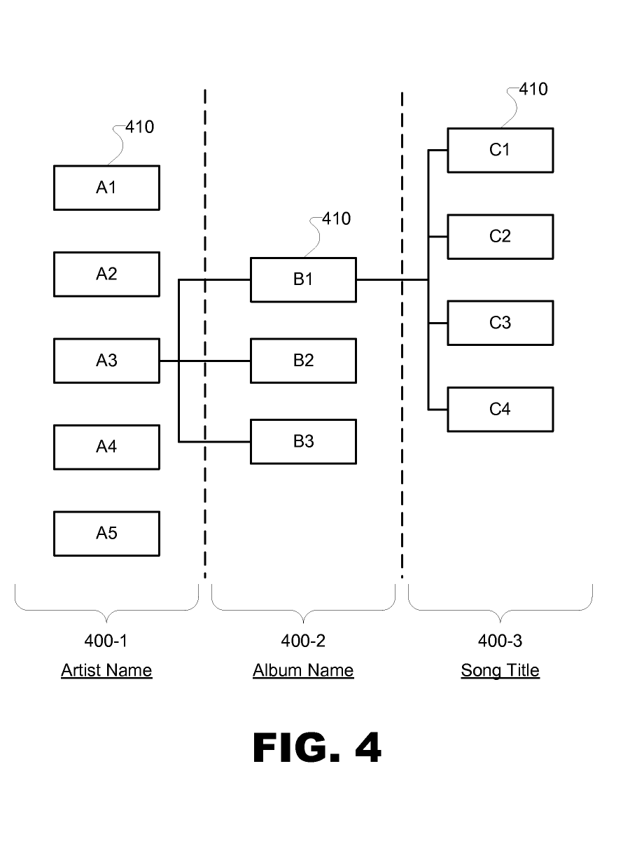

FIG. 4 is a graphical representation of a number of content levels (e.g., 400-1 through 400-3, collectively referred to as “content levels 400”). Three content levels are shown in FIG. 4 for illustrative purposes. It will be recognized that the user may navigate through any number of content levels to access a particular content instance as may serve a particular application.

For illustrative purposes, the exemplary content levels 400 shown in FIG. 4 correspond to audio content (e.g., songs). For example, the first content level 400-1 may correspond to artist names, the second content level 400-2 may correspond to album names, and the third content level 400-3 may correspond to song titles. Content levels 400 may alternatively correspond to any other metadata attributes and may be arranged in any suitable order. Moreover, it will be recognized that content levels 400 may alternatively correspond to any other type of content as may serve a particular application.

In some examples, content levels 400 may be hierarchically organized. In other words, content levels 400 may be presented to a user in a pre-defined hierarchy or ranking. Hence, as a user drills down through a series of content levels 400, the order in which the content levels 400 are presented to the user is in accordance with the pre-defined hierarchy. The hierarchical organization of content levels 400 may be based on the type of content, user preferences, and/or any other factor as may serve a particular application. In some examples, the first content level (e.g., content level 400-1) within a hierarchical organization of levels is referred to as the “top level” while the other content levels (e.g., content levels 400-2 and 400-3) are referred to as “sub-levels”.

Each level 400 may include a number of selectable entries 410. For example, the first level 400-1 shown in FIG. 4 includes entries A1-A5, the second level 400-2 includes entries B1-B3, and the third level 400-3 includes entries C1-C4. Each entry 410 represents a metadata value by which content instances within the content library may be filtered. In this manner, a user may select an entry 410 within one or more content levels 400 to filter the available content instances within a content library based on the metadata value corresponding with the selected entry 410. Such functions of selecting and filtering may be performed for one or more content levels 400 until a desired content instance is located.

To illustrate, each entry 410 within the first content level 400-1 may correspond to a metadata value defining the name of an artist of at least one song within a content library. A user may sort (e.g., scroll) through the various artist names within content level 400-1 and select a desired artist (e.g., entry A3). In response to this selection, the second content level 400-2 is presented to the user. Entries 410 within the second content level 400-2 may correspond to metadata values defining the names of albums within the content library that are associated with the artist selected in content level 400-1. The user may sort through the various album names included within the second content level 400-2 and select a desired album (e.g., entry B1). In response to this selection, the third content level 400-3 is presented to the user. Entries 410 within the third content level 400-3 may correspond to metadata values defining titles of songs within the album selected in content level 400-2. A user may then select a song title within the entries 410 of the third content level 400-3 to access a desired song within the content library.

The use of content levels 400 allows a user to apply multiple filtering criteria to a content library without having to enter text queries. For example, a user may locate a desired media content instance within a content library by navigating through a series of content levels 400 using only the directional keys 300 to provide input.

To illustrate, a user may use the up and down directional keys 300-3 and 300-4 to scroll through entries contained within a first content level (e.g., content level 400-1). When a desired entry is located, the user may press the right directional key 300-2 to select the entry and create a second content level (e.g., content level 400-2) based on the selected entry. The user may again use the up and down directional keys 300-3 and 300-4) to scroll through entries contained within the second content level to locate a desired entry contained therein. To select an entry within the second content level, the user may press the right directional key 300-2. The user may drill down through additional content levels in a similar manner until a desired content instance is located. The user may then select the desired content instance (e.g., with the right directional key 300-2 and/or with the select key 310).

It will be recognized that alternative keys (or other input mechanisms) to those described herein may be used to navigate through a series of content levels 400 and select one or more entries within the content levels 400. For example, the left and right directional keys 300-1 and 300-2 may be used to scroll through entries contained with a particular content level. Likewise, the select key 310 may be used to select an entry within a content level 400. However, for illustrative purposes, the up and down directional keys 300-3 and 300-4 are used to scroll through entries contained within a content level 400 and the right directional key 300-2 is used to select an entry within a content level 400 in the examples given herein.

To facilitate content level navigation as described herein, a GUI may be displayed by access subsystem 120. As will be described in more detail below, the GUI may include one or more graphical objects representing each entry within a particular content level. The graphical objects may be configured to allow a user to visually identify and distinguish entries one from another. In this manner, a user may quickly and efficiently navigate through a series of content levels to locate and/or access a desired content instance.

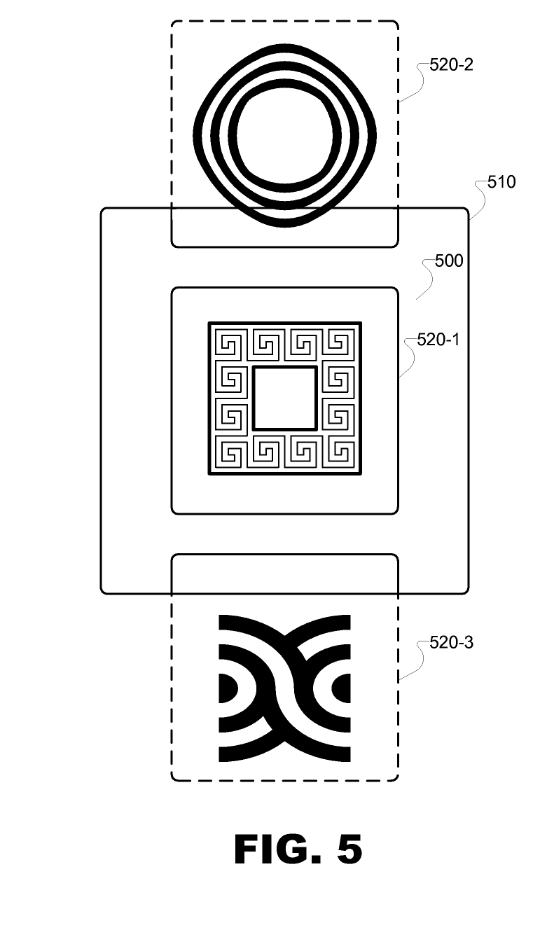

FIG. 5 illustrates an exemplary GUI 500 that may be displayed by access subsystem 120 and that may be configured to facilitate content level navigation. As shown in FIG. 5, GUI 500 may be disposed within a viewing area 510 of a display device (e.g., display 270).

GUI 500 may include one or more graphical objects (e.g., 520-1 through 520-3, collectively referred to herein as “graphical objects 520”) configured to represent entries within a particular content level. Each graphical object 520 may include any image, graphic, text, or combination thereof configured to facilitate a user associating the graphical objects 520 with their respective entries. For example, a graphical object 520 may include an image of album art corresponding to audio content, an image of cover art corresponding to video content, a photograph, an icon, and/or any other graphic as may serve a particular type of content.

In some examples, at least one graphical object 520 is configured to be completely disposed within viewing area 510 at any given time. For example, graphical object 520-1 is completely disposed within viewing area 510 in FIG. 5. Portions of one or more additional graphical objects 520 may also be disposed within viewing area 510 to visually indicate to a user that additional entries are included within a particular content level. For example, portions of graphical objects 520-2 and 520-3 are shown to be disposed within viewing area 510 in FIG. 5. Portions of graphical objects 520 not disposed within viewing area 510 are indicated by dotted lines in FIG. 5 for illustrative purposes.

A user may view various entries with a particular content level by selectively positioning one or more graphical objects 520 within viewing area 510. In some examples, one or more of the directional keys 300 (e.g., the up and down directional keys 300-3 and 300-4) may be used to position the graphical objects 520 within viewing area 510. In this manner, a user may scroll through graphical objects 520 corresponding to entries within a particular content level until a graphical object 520 corresponding to a desired entry is located within viewing area 510. The user may then select the graphical object 520 located within viewing area 510 (e.g., by pressing the right directional key 300-2) to select the desired entry. The order in which the graphical objects 520 are presented to the user within a particular content level may vary as may serve a particular application. For example, the order in which the graphical objects 520 are presented may be based on an alphabetical order of their corresponding entries, a relative popularity of their corresponding entries, and/or any other heuristic or criteria as may serve a particular application.

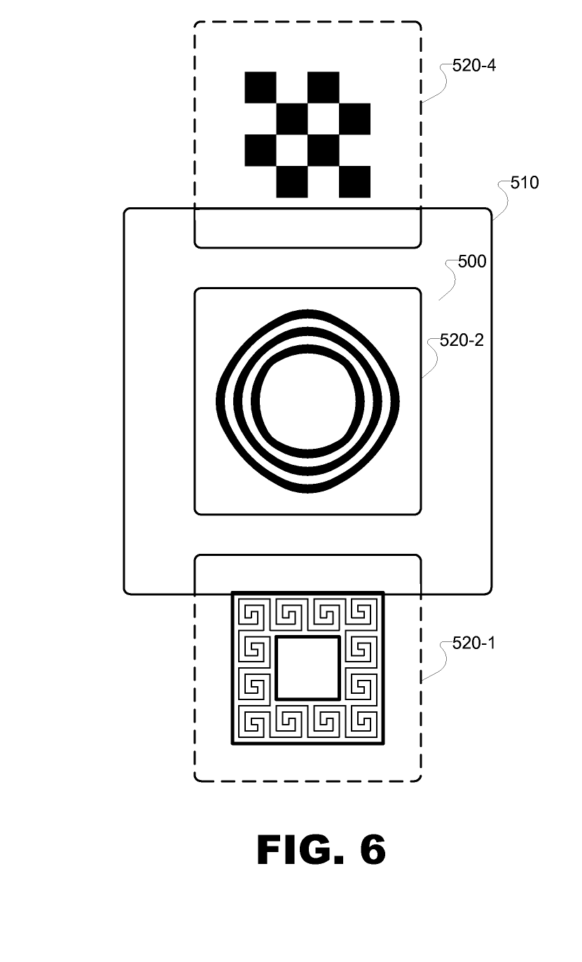

To illustrate, graphical object 520-1 is currently located within viewing area 510 in the example of FIG. 5. To view graphical object 520-2, the user may press the up directional key 300-3. FIG. 6 shows GUI 500 after the up directional key 300-3 has been pressed. As shown in FIG. 6, graphical object 520-2 is now located within viewing area 510 and graphical object 520-1 has shifted down such that it is only partially located within viewing area 510. If graphical object 520-2 corresponds to an entry of interest to the user, the user may select the graphical object 520-2 by pressing a suitable key (e.g., the right directional key 300-2).

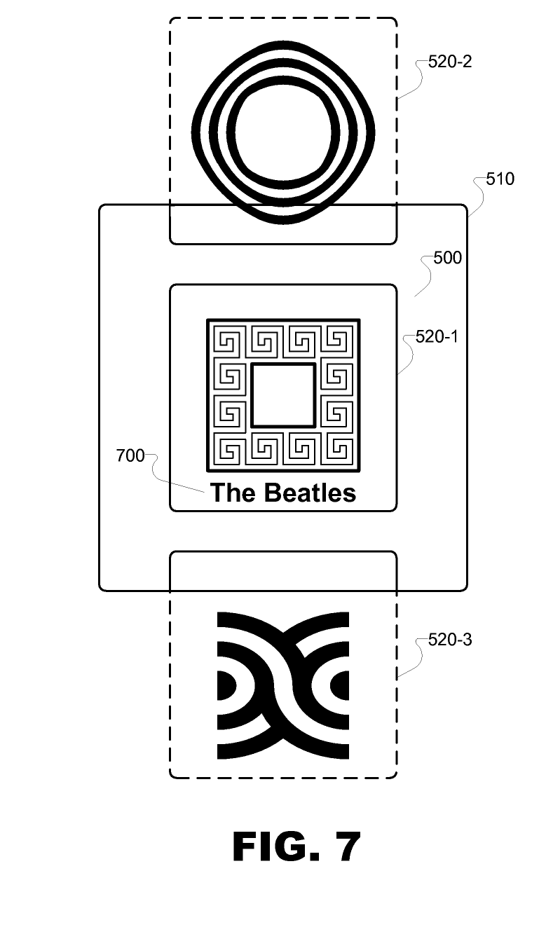

In some examples, contextual information may be displayed in conjunction with the graphical objects 520 to further assist the user in identifying one or more entries corresponding to the graphical objects 520. For example, FIG. 7 shows the GUI 500 of FIG. 5 with contextual information 700 corresponding to graphical object 520-1 displayed therein. In the example of FIG. 7, contextual information 700 shows that graphical object 520-1 corresponds to an artist named “The Beatles.” It will be recognized that contextual information 700 may vary depending on the particular content level and/or graphical object 520.

The particular graphical object 520 that is used to represent each entry within a content level may be determined using a variety of different methods. For example, metadata values corresponding to one or more content instances may define an association between one or more graphical objects 520 and one or more content level entries associated with the content instances. To illustrate, metadata values corresponding to one or more audio content instances may specify that an image of a particular album cover be used as the graphical object that represents a particular artist, genre, or other audio content instance attribute.

Alternatively, a user may manually designate an association between one or more graphical objects and one or more content level entries. For example, a user may designate an image of a particular album cover as the graphical object that represents a particular artist, genre, or other audio content image attribute.

The association between one or more graphical objects and one or more content level entries may additionally or alternatively be automatically determined based on a pre-defined heuristic. For example, if images of album art are used as graphical objects to represent audio content artists within a particular content level, a pre-defined heuristic may be used to determine which album art is used to represent a particular artist having multiple albums of content within a content library. The pre-defined heuristic may be based on one or more metadata values, a relative popularity of the albums and/or audio content instances included therein, user-defined ratings of the albums, content provider preferences, and/or any other criteria as may serve a particular application.

An example will now be presented wherein the graphical objects 520 illustrated in FIGS. 5-6 correspond to audio content. In this particular example, a user may navigate through a series of three content levels to access a particular audio content instance (e.g., a song) within a content library. For illustrative purposes only, the first content level within the three content levels corresponds to artist names, the second content level corresponds to album names, and the third content level corresponds to titles of songs.

The user may first scroll through the graphical objects 520 corresponding to artist names within the first content level until a graphical object 520 corresponding to the artist of the desired audio content instance is located. For example, if graphical object 520-1 in FIG. 5 represents “The Beatles” and graphical object 520-2 represents “Bach,” the user may scroll up (e.g., by pressing the up directional key 300-3) until graphical object 520-2 is positioned within viewing area 510.

One of the many advantages of the present systems and methods is that even if a content library includes songs from multiple albums associated with a particular artist, only one image of album art may be presented to the user to represent the artist. In this manner, the user does not have to scroll through multiple images of album art associated with each artist until a desired artist is located. For example, a content library may have multiple albums associated with “The Beatles.” However, only one image of album art (e.g., graphical object 520-1) is presented to the user. In this manner, the user only has to press the up directional key 300-3 once to access another entry (e.g., graphical object 520-2) within the artist name content level.

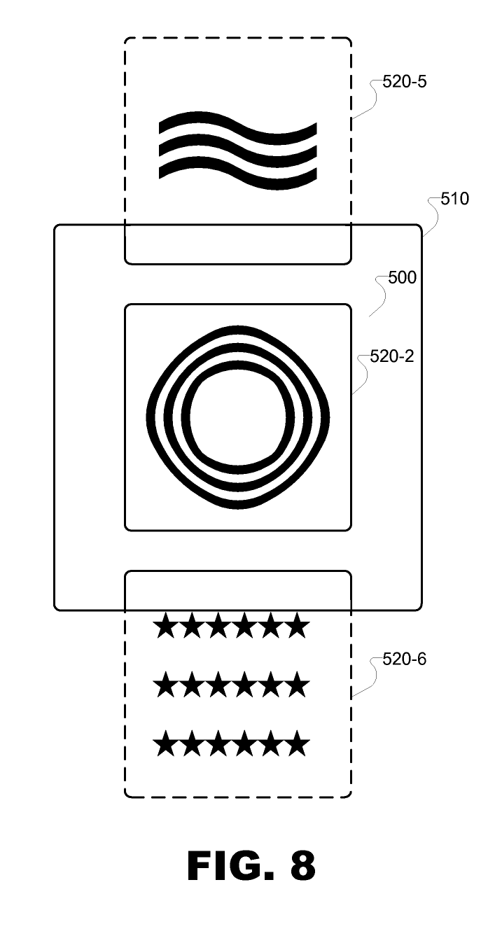

After the graphical object 520-2 representing “Bach” is positioned within viewing area 510, the user may select the graphical object 520-2 (e.g., by pressing the right directional key 300-2) to create a second content level containing album names associated with “Bach.” FIG. 8 shows GUI 500 after graphical object 520-2 has been selected. As shown in FIG. 8, a number of graphical objects (e.g., 520-2, 520-5, and 520-6) are included within GUI 500. The graphical objects 520 now represent entries within a second content level corresponding to album titles. Hence, each graphical object 520 may include an image of album art corresponding to an album associated with the artist “Bach” within content library.

The user may scroll through the graphical objects 520 associated with entries within the second content level (e.g., by pressing the up and down directional keys 300-3 and 300-4) until a graphical object 520 representing a desired album is located within viewing area 510. In some examples, contextual information may be displayed in conjunction with the graphical objects 520 associated with entries within the second content level. The contextual information may include the title of the albums and/or other information related to the albums, for example.

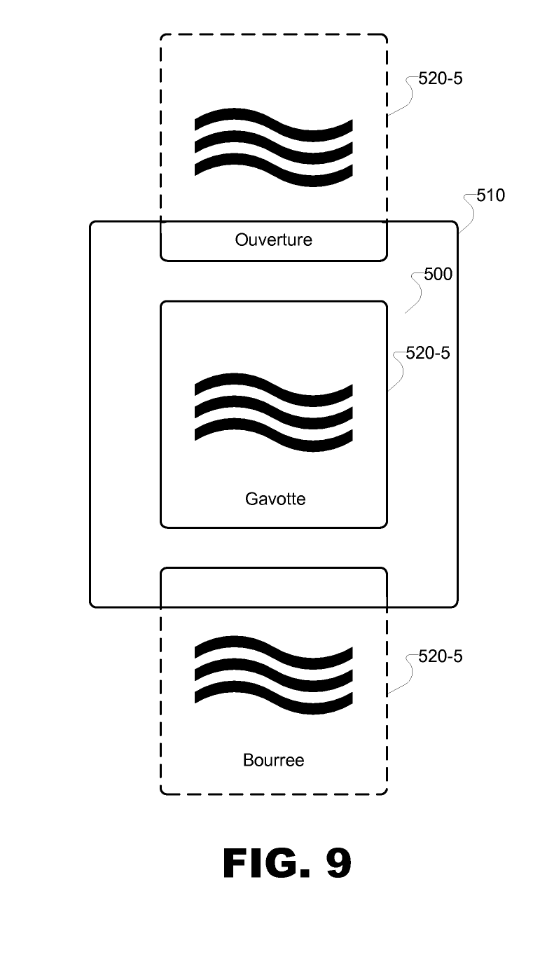

After a graphical object 520 (e.g., graphical object 520-5) representing a desired album is positioned within viewing area 510, the user may select the graphical object 520-5 (e.g., by pressing the right directional key 300-2) to create a third content level containing entries corresponding to names of audio content instances included within the desired album. To illustrate, FIG. 9 shows GUI 500 after graphical object 520-5 has been selected. As shown in FIG. 9, GUI 500 may include a representation of the same graphical object 520-5 for each audio content instance to visually indicate that each audio content instance is included within the same album.

Each graphical object 520-5 may include contextual information indicating the name of its corresponding audio content instance. For example, FIG. 9 shows that certain audio content instances included in the album represented by graphical object 520-5 are named “Ouverture, “Gavotte,” and “Bourree.” A user may scroll through the graphical objects 520-5 (e.g., by pressing the up and down directional keys 300-3 and 300-4) and select a desired audio content instance (e.g., by pressing the right directional key 300-2). Access subsystem 120 may then play, purchase, or otherwise process the selected audio content instance.

While the preceding example corresponds to audio content, it will be recognized that a user may access other types of content within a content library in a similar manner. For example, graphical objects 520 may be configured to represent entries associated with video, photographs, multimedia, and/or any other type of content.

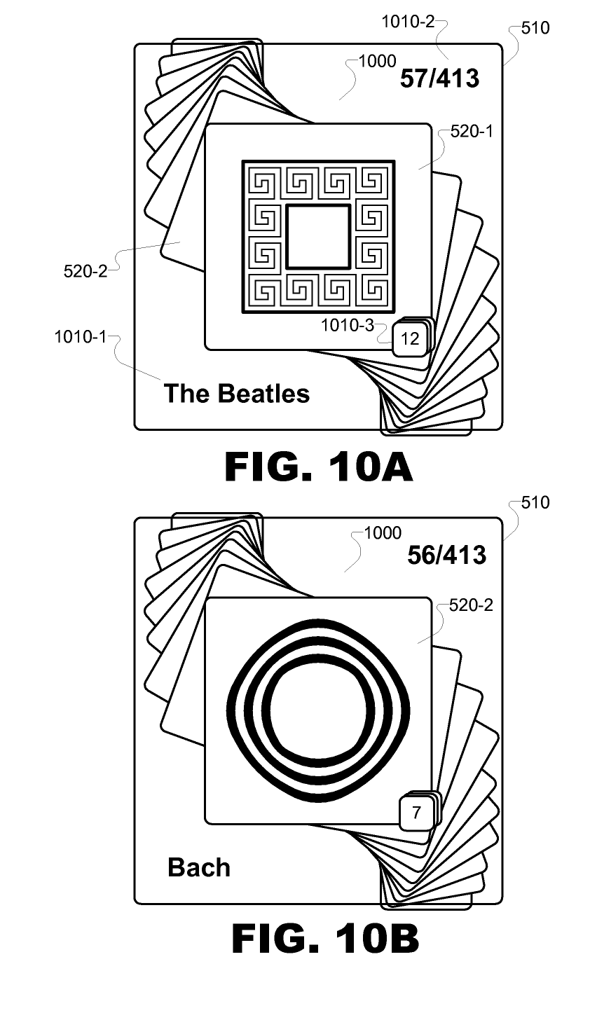

It will be recognized that the graphical objects 520 shown in FIGS. 5-9 may be displayed by access subsystem 120 in any suitable arrangement or manner. To illustrate, FIGS. 10A-10B illustrate an exemplary GUI 1000 configured to present one or more graphical objects 520 to a user.

As shown in FIGS. 10A-10B, the graphical objects 520 may be arranged as a stacked “S” curve. The stacked S-curve arrangement shown in FIGS. 10A-10B is illustrative of the many arrangements that may be used to graphically convey the presence of multiple entries within a particular content level. A user may scroll or “flip” through the graphical objects 520 until a desired graphical object 520 is positioned at the top of the stacked S-curve. The user may then select the desired graphical object 520 to select an entry within a content level corresponding thereto.

For example, graphical object 520-1 representing “The Beatles” is shown to be positioned on top of the stacked S-curve in FIG. 10A. To select an entry corresponding to “Bach,” the user may press the up directional key until graphical object 520-2 is positioned on top of the stacked S-curve, as shown in FIG. 10B.

As shown in FIGS. 10A-10B, contextual information (e.g., 1010-1, 1010-2, and 1010-3, collectively referred to herein as “contextual information 1010”) may be displayed within GUI 1000. Contextual information 1010 may be configured to provide information corresponding to one or more of the graphical objects 520. For example, the contextual information 1010 may provide a name of an entry corresponding to a particular graphical object (e.g., 1010-1), the number of entries within a particular content level (e.g., 1010-2), and/or information corresponding to a sub-level filtered by a particular entry (e.g., 1010-3).

In some examples, access subsystem 120 may be configured to adjust the arrangement of the graphical objects 520 to convey a scrolling speed therethrough. For example, with respect to the stacked S-curve arrangement shown in FIGS. 10A-10B, if one of directional keys 300 (e.g., the up or down directional key 300-3 or 300-4) is maintained in an actuated position, the speed at which the graphical objects 520 are scrolled through the viewing area 510 may be configured to increase.

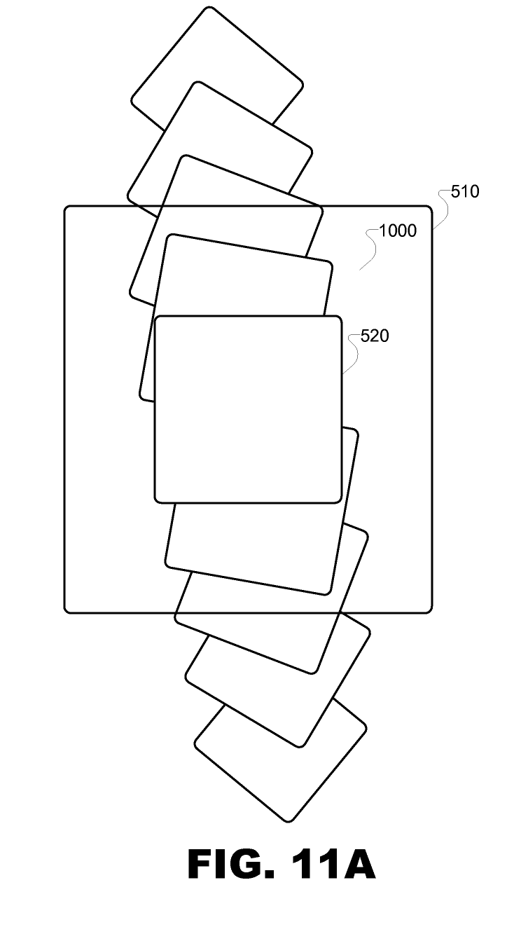

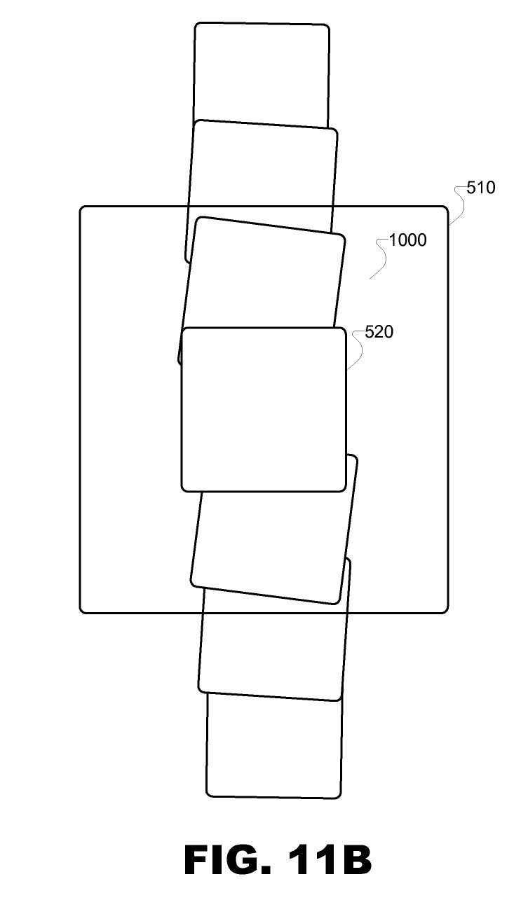

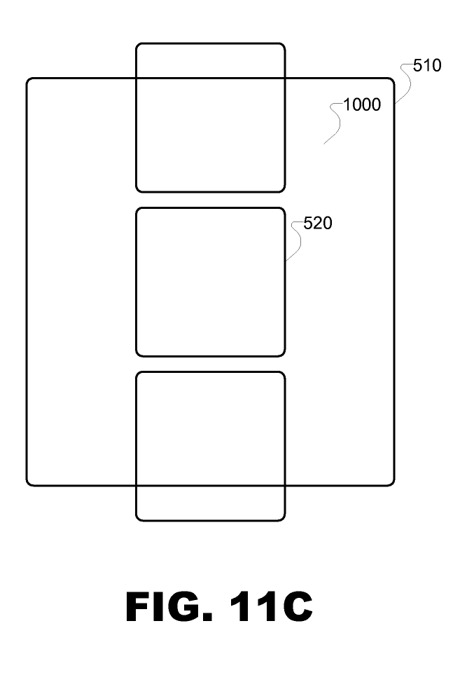

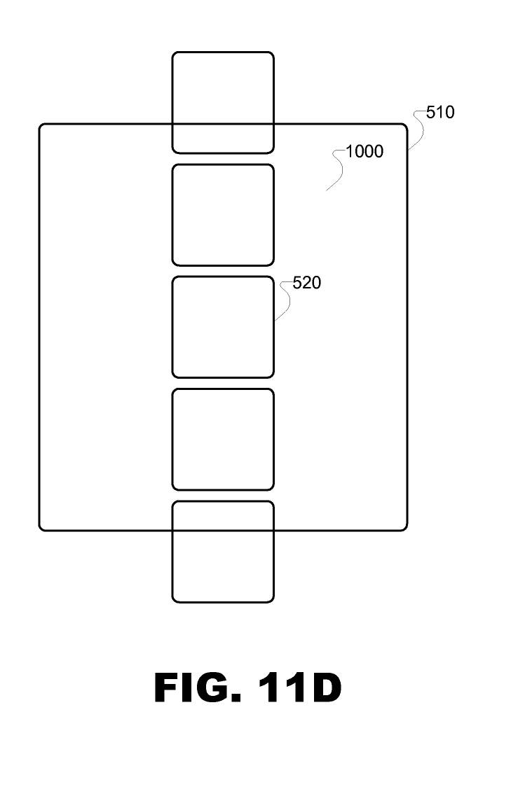

FIGS. 11A-11D illustrate various screen shots of GUI 1000 as the scrolling speed increases. As shown in FIG. 11A, the stacked S-curve arrangement of the graphical objects 520 may begin to straighten out toward becoming linear as the scrolling speed increases. As the scrolling speed increases even more, the graphical objects 520 may be positioned in even more of a linear arrangement, as shown in FIG. 11B. In FIG. 11C, the graphical objects 520 have become completely linear. The size of the graphical objects 520 may be decreased (e.g., by zooming out) as the scrolling speed continues to increase, as shown in FIG. 11D. In some examples, the graphical objects 520 may resume their stacked S-curve arrangement when the scrolling ceases or sufficiently decreases in speed.

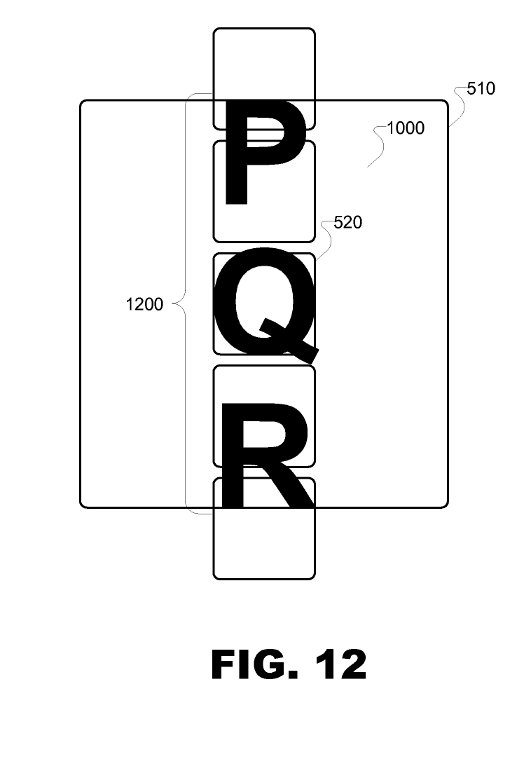

As shown in FIG. 12, a graphical overlay 1200 configured to provide contextual information corresponding to one or more entries within a content level may additionally or alternatively be displayed within viewing area 510 as the scrolling speed increases. The graphical overlay 1200 may include one or more letters representing the first letter of entries within a particular content level, for example. As the graphical objects 520 scroll through the viewing area 510, the letters may be updated to correspond to the particular graphical objects 520 that are positioned within the viewing area 510. It will be recognized that the graphical overlay 1200 may include additional or alternative information as may serve a particular application.

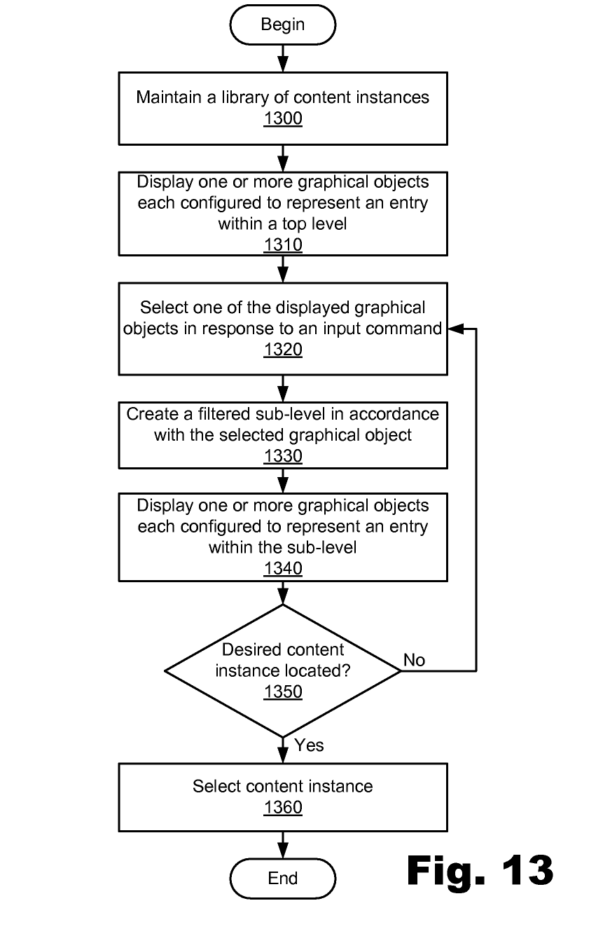

FIG. 13 illustrates an exemplary content instance locating method. While FIG. 13 illustrates exemplary steps according to one embodiment, other embodiments may omit, add to, reorder, and/or modify any of the steps shown in FIG. 13.

In step 1300, a library of content instances is maintained. The content library may be maintained by a content access subsystem and/or by a content provider subsystem.

In step 1310, a set of one or more graphical objects each configured to represent an entry within a top level or a first content level are displayed. In some examples, the top level may correspond to a first metadata attribute associated with the library of content instances. For example, the top level may correspond to names of artists of one or more of the content instances within the content library or any other metadata value as may serve a particular application. In some examples, the graphical objects may be configured to scroll through a viewing area of a display in response to one or more input commands (e.g., selecting the up and down directional keys 300-3 and 300-4).

In step 1320, a graphical object corresponding to a desired entry within the top level is selected in response to an input command. For example, when a graphical object corresponding to the desired entry is positioned within the viewing area, the user may press the right directional key 300-2 to facilitate selection of the graphical object.

In step 1330, a filtered sub-level is created in accordance with the selected graphical object. The filtered sub-level corresponds to a second metadata attribute associated with the library of content instances. For example, the sub-level may correspond to names of albums associated with the selected entry within the top level.

In step 1340, a set of one or more graphical objects each configured to represent an entry within the sub-level is displayed. One or more additional sub-levels may be created in a similar manner (repeat steps 1320-1340) until a desired content instance is located (Yes; step 1350). In step 1360, the desired content instance is selected.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A system comprising:
a content provider subsystem configured to maintain a plurality of content instances; and
a content access subsystem selectively and communicatively coupled to said content provider subsystem;
wherein said content access subsystem is configured to
provide a first set of one or more graphical objects to a display for presentation to a user, each graphical object within said first set of said graphical objects representing an entry within a first content level corresponding to a first metadata attribute associated with said content instances,
select one of said graphical objects in response to an input command, and
provide a second set of one or more graphical objects to said display for presentation to said user, each graphical object within said second set of said graphical objects representing an entry within a second content level corresponding to a second metadata attribute associated with said content instances, said entries within said second content level being filtered in accordance with said selected graphical object within said first content level.

2. The system of claim 1, wherein said content access subsystem is further configured to:
select one of said graphical objects corresponding to one of said entries within said second content level in response to another input command; and
access one of said content instances associated with said selected graphical object within said second content level.

3. The system of claim 1, wherein said content access subsystem is further configured to provide at least one additional set of one or more graphical objects to said display for presentation to said user in response to at least one additional input command, said at least one additional set of said graphical objects being configured to facilitate access to a content instance within said plurality of content instances.

4. The system of claim 1, wherein said content access subsystem is further configured to scroll one or more graphical objects within said first set of said graphical objects across a viewing area of said display in response to one or more input commands.

5. The system of claim 4, wherein said content access subsystem comprises one or more directional keys, and wherein actuation of one of said directional keys is configured to generate said one or more input commands configured to scroll said one or more graphical objects within said first set of said graphical objects across said viewing area of said display.

6. The system of claim 1, wherein said graphical objects within said first and second sets of said graphical objects comprise images configured to facilitate association of said graphical objects within said first and second sets of said graphical objects with one or more of said entries within said first and second content levels.

7. The system of claim 1, wherein said first metadata attribute comprises a category of artist names associated with said plurality of said content instances, and wherein at least one graphical object within said first set of one or more graphical objects comprises an image of album art corresponding to an artist associated with one or more of said content instances.

8. The system of claim 1, wherein said content access subsystem is further configured to associate each of said graphical objects within said first and second sets of said graphical objects with one or more of said entries within said first and second content levels in accordance with a pre-defined heuristic.

9. The system of claim 1, wherein said content access subsystem is configured to display at least one of said first and second sets of said graphical objects in a stacked S-curve arrangement.

10. The system of claim 1, wherein said content access subsystem is further configured to provide a graphical overlay to said display for presentation to said user, said graphical overlay configured to provide contextual information corresponding to one or more of said entries within at least one of said first and second content levels.

11. An apparatus comprising:
at least one processor;
at least one facility configured to direct said at least one processor to
generate a first set of one or more graphical objects, each graphical object within said first set of said graphical objects representing an entry within a first content level corresponding to a first metadata attribute associated with a plurality of content instances,
select one of said graphical objects in response to an input command, and
generate a second set of one or more graphical objects, each graphical object within said second set of said graphical objects representing an entry within a second content level corresponding to a second metadata attribute associated with said content instances, said entries within said second content level being filtered in accordance with said selected graphical object within said first content level; and
an output driver configured to provide said first and second sets of said graphical objects to a display for presentation to a user.

12. The apparatus of claim 11, wherein said at least one facility is further configured to direct said at least one processor to:
select one of said graphical objects corresponding to one of said entries within said second content level in response to another input command; and
access one of said content instances associated with said selected graphical object within said second content level.

13. The apparatus of claim 11, wherein said at least one facility is further configured to direct said at least one processor to provide at least one additional set of one or more graphical objects in response to at least one additional input command, said at least one additional set of said graphical objects being configured to facilitate access to at least one of said content instances.

14. The apparatus of claim 11, wherein said output driver is further configured to scroll one or more graphical objects within said first set of said graphical objects across a viewing area of said display in response to one or more input commands.

15. The apparatus of claim 14, further comprising one or more directional keys configured to provide said one or more input commands configured to scroll said one or more graphical objects within said first set of said graphical objects across said viewing area of said display.

16. The apparatus of claim 11, wherein said graphical objects within said first and second sets of said graphical objects comprise images configured to facilitate association of said graphical objects within said first and second sets of said graphical objects with one or more entries within said first and second content levels.

17. The apparatus of claim 11, wherein said at least one facility is further configured to direct said at least one processor to associate each of said graphical objects within said first and second sets of said graphical objects with one or more of said entries within said first and second content levels in accordance with a pre-defined heuristic.

18. The apparatus of claim 11, wherein said output driver is further configured to direct said display to display at least one of said first and second sets of said graphical objects in a stacked S-curve arrangement.

19. A method comprising:
maintaining a plurality of content instances;
displaying one or more graphical objects each configured to represent an entry within a first content level corresponding to a first metadata attribute associated with said content instances;
selecting one of said graphical objects in response to an input command; and
displaying one or more graphical objects each configured to represent an entry within a second content level corresponding to a second metadata attribute associated with said content instances, said entries within said second content level being filtered in accordance with said selected graphical object in said first content level.

20. The method of claim 19, further comprising:
selecting one of said graphical objects corresponding to one of said entries within said second content level in response to another input command; and
accessing one of said content instances associated with said selection of said graphical object corresponding to said entry within said second content level.

21. The method of claim 19, further comprising displaying at least one additional set of one or more graphical objects in response to at least one additional input command, said at least one additional set of said graphical objects being configured to facilitate access to one of said content instances.

22. The method of claim 19, wherein said first metadata attribute corresponds to a category of artist names associated with said plurality of said content instances, and wherein at least one graphical object within said first set of one or more graphical objects comprises an image of album art corresponding to an artist associated with one or more of said content instances.

23. The method of claim 19, further comprising associating each of said graphical objects within said first and second sets of said graphical objects with one or more of said entries within said first and second content levels in accordance with a pre-defined heuristic.

24. The method of claim 19, further comprising displaying at least one of said first and second sets of said graphical objects in a stacked S-curve arrangement.
